(19) United States
(12) Patent Application Publication
(10) Pub. No.: US 2021/0152869 A1
(43) Pub. Date: May 20, 2021

(54) Driving Record Video Collection System For Traffic Accident And Method Thereof

(71) Applicants: Inventec (Pudong) Technology Corporation, Shanghai (CN); Inventec Corporation, Taipei City (TW)

(72) Inventor: Chaucer Chiu, Shanghai (CN)

(21) Appl. No.: 16/721,605

(22) Filed: Dec. 19, 2019

(30) Foreign Application Priority Data
Nov. 18, 2019 (CN) 201911126516.X

(51) Int. Cl. H04N 21/4223; G08G 1/04; G07C 5/08

(52) U.S. Cl. CPC H04N 21/4223; H04W 4/029; G07C 5/085; G08G 1/04

(57) ABSTRACT

A driving record video collection system for a traffic accident and a method thereof are disclosed. In the moment of the traffic accident, a first vehicle-mounted device provides video collection information and an accident driving video to a server, the server selects a query range according to accident position information, and selects a time interval according to an accident time, and then finds out second device identification information when second position information is within the query range and second time information is within the time interval, thereby obtaining an auxiliary driving video from a second vehicle-mounted device with the second device identification information. Therefore, attributions of responsibility for the traffic accident can be determined according to the accident driving video and the auxiliary driving video, thereby achieving effect of improving accuracy of determining responsibility for the traffic accident according to the collected accident and auxiliary driving videos.

### CROSS-REFERENCE TO RELATED APPLICATION

This application claims the benefit of Chinese Application Serial No. 201911126516.X filed Nov. 18, 2019, which is hereby incorporated herein by reference in its entirety.

### BACKGROUND OF THE INVENTION

### 1. Field of the Invention

The present invention relates to an video collection system and a method thereof, and more particularly to a driving record video collection system for a traffic accident in which a vehicle-mounted device provides video collection information and an accident driving video to a server in the moment of a traffic accident, and the server obtains an auxiliary driving video from other eligible vehicle-mounted device according to the video collection information, and a method thereof.

### 2. Description of the Related Art

Generally, when a traffic accident occurs, the responsibility for the traffic accident is judged by the words of the two parties and police officer's actual measurement in the traffic accident. In addition, if there is a witness at the moment of the traffic accident, the witness's words can assist in judging the responsibility of the traffic accident.

With advancement of vehicle-mounted devices, the vehicle-mounted device can record videos around the road on which the vehicle is driving, and such videos are called as driving record videos. The driving record videos recorded by the vehicle mounted device are clearer than the wording of two parties in the traffic accident, and can be used as evidence of attributions of responsibility for the traffic accident. However, the videos recorded by the vehicle-mounted device can record the occurrence of the traffic accident in a single view angle only. Since the existing driving record videos lack witness testimonies or witness videos captured in a third view angle, it is still difficult in judging the responsibility of a traffic accident.

Therefore, the conventional technology has a problem that it is still difficult to accurately judge the attributions of responsibility for a traffic accident according to the words of the two parties in the traffic accident and police officer's actual measurement on site, so it is necessary to provide an improved technical solution to solve this problem.

### SUMMARY OF THE INVENTION

An objective of the present invention is to provide a driving record video collection system for a traffic accident and a method thereof, in order to solve the conventional technical problem that it is difficult to accurately judge attributions of responsibility for the traffic accident according to words of two parties in the traffic accident and police officer's actual measurement on site.

In order to achieve the objective, the present invention provides a driving record video collection system for a traffic accident including a first vehicle-mounted device, a second vehicle-mounted device, and a server. The first vehicle-mounted device is disposed in a first vehicle and stores first device identification information. The first vehicle-mounted device comprises a first driving recorder module, a first positioning module, an impact detection module, a first video capturing module, and a first device transmitting module. The second vehicle-mounted device is disposed in a second vehicle and stores second device identification information. The second vehicle-mounted device comprises a second driving recorder module, a second positioning module, a device receiving module, a second video capturing module, and a second device transmitting module. The server comprises a server receiving module, a storage module, a query module, a generating module, and a server transmitting module.

The first driving recorder module of the first vehicle-mounted device is configured to record a first driving record video when the first vehicle is in driving. The first positioning module of the first vehicle-mounted device is configured to periodically obtain first position information of the first vehicle-mounted device. The impact detection module of the first vehicle-mounted device is configured to generate video collection information according to an accident time and accident position information when the impact detection module detects an external impact force. The first video capturing module of the first vehicle-mounted device is configured to capture an accident driving video within a time interval from a predetermined period before the accident time to the accident time, from the first driving record video. The first device transmitting module of the first vehicle-mounted device is configured to transmit the first device identification information, the first position information, and first time information of obtaining the first position information, and transmit the video collection information and the accident driving video.

The second driving recorder module of the second vehicle-mounted device is configured to record a second driving record video when the second vehicle is in driving. The second positioning module of the second vehicle-mounted device is configured to periodically obtain second position information of the second vehicle-mounted device. The device receiving module of the second vehicle-mounted device is configured to receive video capturing information. The second video capturing module of the second vehicle-mounted device is configured to capture an auxiliary driving video within the time interval from the predetermined period before the accident time to the accident time, from the second driving record video according to the video capturing information. The second device transmitting module of the second vehicle-mounted device is configured to transmit the second device identification information, the second position information, and second time information of obtaining the second position information; and to transmit the auxiliary driving video.

The server receiving module of the server is configured to receive the first device identification information, the first position information, and the first time information from the first device transmitting module; and to receive the second device identification information; the second position information, and the second time information from the second device transmitting module, and to receive the video collection information and the accident driving video from the first device transmitting module, and to receive the auxiliary driving video from the second device transmitting module. The storage module of the server is configured to store the first device identification information, the first position information, and the first time information corresponding to each other, and to store the second device identification information, the second position information, and the second time information responding to each other. The query module of the server is configured to select a query range according to the accident position information of the video collection information, and to select a time interval according to the accident time of the video collection information, and to find out the second device identification information when the second position information is within the query range and the second time information is within the time interval. The generating module of the server is configured to generate the video capturing information according to the found second device identification information and the accident time. The server transmitting module of the server is configured to transmit the video capturing information to the device receiving module.

In order to achieve the objective, the present invention provides a driving record video collection method for a traffic accident including following steps.

First, a first vehicle-mounted device is disposed in a first vehicle, and the first vehicle-mounted device stores first device identification information. Next, a second vehicle-mounted device is disposed in a second vehicle, and the second vehicle-mounted device stores second device identification information. Next, the first vehicle-mounted device records first driving record video when the first vehicle is in driving. Next, the second vehicle-mounted device records second driving record video when the second vehicle is in driving. Next, the first vehicle-mounted device acquires the first position information of the first vehicle-mounted device regularly. Next, the second vehicle-mounted device acquires the second position information of the second vehicle-mounted device regularly. Next, the first vehicle-mounted device transmits the first device identification information, the first position information, first time information of obtaining the first position information, to the server. Next, the second vehicle-mounted device transmits the second device identification information, the second position information, second time information of obtaining the second position information, to the server. Next, the server stores the first device identification information, the first position information, and the first time information corresponding to each other. Next, the server stores the second device identification information, the second position information, and the second time information corresponding to each other. Next, when the first vehicle-mounted device detects an external impact force, the first vehicle-mounted device generates video collection information according to an accident time and accident position information. Next, according to the accident time, the first vehicle-mounted device captures an accident driving video within a time interval from a predetermined period before the accident time to the accident time, from the first driving record video. Next, the first vehicle-mounted device transmits the video collection information and the accident driving video to the server. Next, the server selects a query range according to the accident position information contained in the video collection information, selects a time interval according to the accident time contained in the video collection information, and finds out the second device identification information when the second position information is within the query range and the second time information is within the time interval. Next, the server generates video capturing information according to the found second device identification information and the accident time. Next, the server transmits the video capturing information to the second vehicle-mounted device. Next, according to the video capturing information, the second vehicle-mounted device captures an auxiliary driving video within the time interval from the predetermined period before the accident time to the accident time, from the second driving record video. Eventually, the second vehicle-mounted device transmits the auxiliary driving video to the server.

According to the above-mentioned content, the difference between the conventional technology and the system and method of the present invention is that the first vehicle-mounted device can provide the video collection information and the accident driving video to the server in the moment of a traffic accident, the server can select the query range according to the first position information contained in the video collection information, select the time interval according to the accident time contained in the video collection information, and find out the second device identification information when the second position information is within the query range and the second time information is within the time interval, so as to obtain the auxiliary driving video from the second vehicle-mounted device, so that the attributions of responsibility for the traffic accident can be judged according to the accident driving video and the auxiliary driving video.

By the above-mentioned technical solution, the present invention can achieve the technical effect of improving accuracy of judging attributions of responsibility for the traffic accident according to the accident driving video and auxiliary driving video.

### BRIEF DESCRIPTION OF THE DRAWINGS

The structure, operating principle and effects of the present invention will be described in detail by way of various embodiments which are illustrated in the accompanying drawings.

FIG. 1 is a system block diagram of a driving record video collection system for a traffic accident of the present invention.

FIG. 2 is a system framework diagram of collecting a driving record video of a traffic accident, according to an embodiment of the present invention.

FIGS. 3A to 3C are flowcharts of a driving record video collection method for a traffic accident of the present invention.

### DETAILED DESCRIPTION OF THE PREFERRED EMBODIMENTS

The following embodiments of the present invention are herein described in detail with reference to the accompanying drawings. These drawings show specific examples of the embodiments of the present invention. These embodiments are provided so that this disclosure will be thorough and complete, and will fully convey the scope of the invention to those skilled in the art. It is to be acknowledged that these embodiments are exemplary implementations and are not to be construed as limiting the scope of the present invention in any way. Further modifications to the disclosed embodiments, as well as other embodiments, are also included within the scope of the appended claims. These embodiments are provided so that this disclosure is thorough and complete, and fully conveys the inventive concept to those skilled in the art. Regarding the drawings, the relative proportions and ratios of elements in the drawings may be exaggerated or diminished in size for the sake of clarity and convenience. Such arbitrary proportions are only illustrative and not limiting in any way. The same reference numbers are used in the drawings and description to refer to the same or like parts.

It is to be acknowledged that, although the terms ‘first’, ‘second’, ‘third’, and so on, may be used herein to describe various elements, these elements should not be limited by these terms. These terms are used only for the purpose of distinguishing one component from another component. Thus, a first element discussed herein could be termed a second element without altering the description of the present disclosure. As used herein, the term “or” includes any and all combinations of one or more of the associated listed items.

It will be acknowledged that when an element or layer is referred to as being “on,” “connected to” or “coupled to” another element or layer, it can be directly on, connected or coupled to the other element or layer, or intervening elements or layers may be present. In contrast, when an element is referred to as being “directly on,” “directly connected to” or “directly coupled to” another element or layer, there are no intervening elements or layers present.

In addition, unless explicitly described to the contrary, the word “comprise”, “include” and “have”, and variations such as “comprises”, “comprising”, “includes”, “including”, “has” and “having” will be acknowledged to imply the inclusion of stated elements but not the exclusion of any other elements.

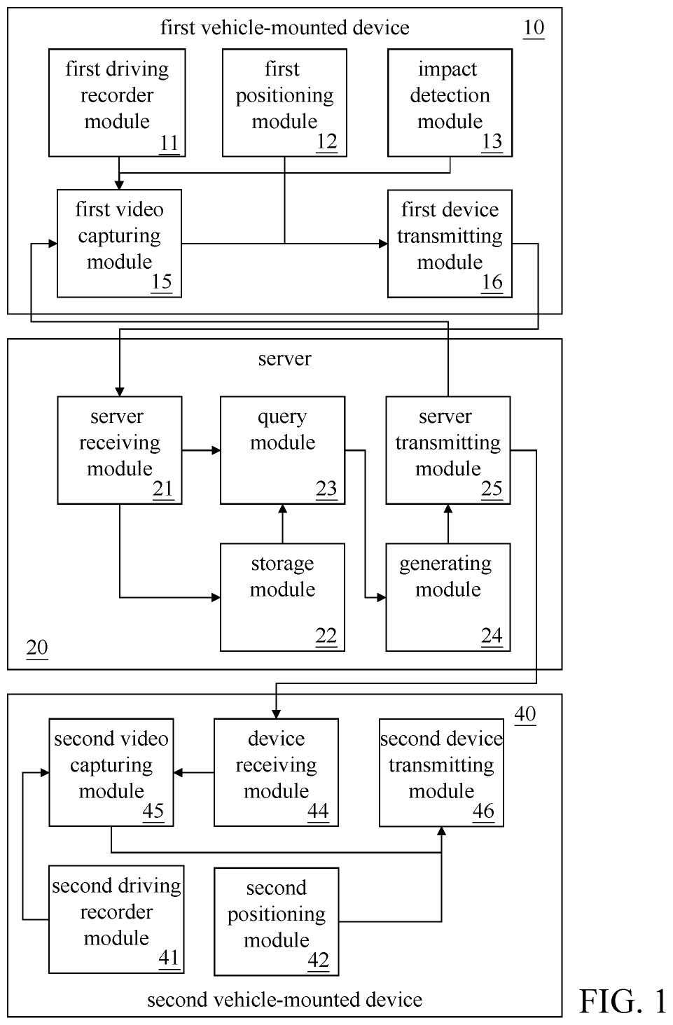

A driving record video collection system for a traffic accident of the present invention is illustrated in the following paragraphs. Please refer to FIG. 1, which is a system block diagram of a driving record video collection system for a traffic accident of the present invention.

The driving record video collection system of the present invention comprises a first vehicle-mounted device 10, a second vehicle-mounted device 40, and a server 20. The first vehicle-mounted device 10 is disposed in the first vehicle and stores first device identification information. The first vehicle-mounted device 10 comprises a first driving recorder module 11, a first positioning module 12, an impact detection module 13, an first video capturing module 15, and a first device transmitting module 16. The second vehicle-mounted device 40 is disposed in the second vehicle and stores second device identification information. The second vehicle-mounted device 40 comprises a second driving recorder module 41, a second positioning module 42, an device receiving module 44, an second video capturing module 45, and a second device transmitting module 46. The server 20 comprises a server receiving module 21, a storage module 22, a query module 23, a generating module 24, and a server transmitting module 25.

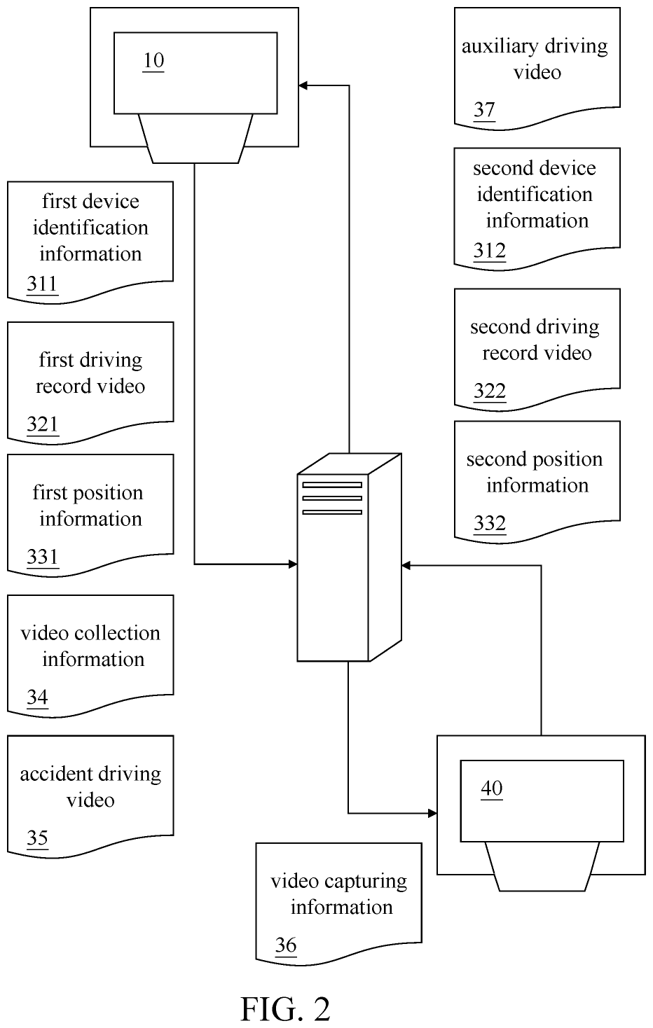

Please refer to FIGS. 1 and 2. FIG. 2 is a system framework diagram of collecting a driving record video of a traffic accident, according to the present invention.

The first vehicle-mounted device 10 and the second vehicle-mounted device 40 are the same vehicle-mounted devices in fact. In an embodiment, the first vehicle-mounted device 10 is a vehicle-mounted device mounted in the first vehicle occurring a traffic accident, and the second vehicle-mounted device 40 is a vehicle-mounted device mounted in the second vehicle which possibly witnessed the traffic accident. For illustrative convenience, the first vehicle-mounted device 10 and the second vehicle-mounted device 40 represent different vehicle-mounted devices.

The first vehicle-mounted device 10 stores first device identification information 311, and the second vehicle-mounted device 40 stores second device identification information 312. The first driving recorder module 11 of the first vehicle-mounted device 10 records first driving record video 321 when the first vehicle is in driving, and the second driving recorder module 41 of the second vehicle-mounted device 40 records second driving record video 322 when the second vehicle is in driving. The first positioning module 12 of the first vehicle-mounted device 10 can periodically obtain first position information 331 of the first vehicle-mounted device 201, and the second positioning module 12 of the second vehicle-mounted device 40 can periodically obtain second position information 332 of the second vehicle-mounted device 202. The manners that the first vehicle-mounted device 10 and the second vehicle-mounted device 40 record the first driving record video 321 and the second driving record video 322, and the first vehicle-mounted device 10 and the second vehicle-mounted device 40 periodically obtain the first position information 331 and the second position information 332, respectively, can be referred to illustration in prior art, so detailed descriptions are omitted herein. Each of the first device identification information 311 and the second device identification information 312 can be a media access control address, and each of the first position information 331 and the second position information 332 can be global positioning coordinate information, but these examples are merely for exemplary illustration, and the application field of the present invention is not limited thereto.

The first vehicle-mounted device 10 and the second vehicle-mounted device 40 are interconnected to the server 20 through a wireless transmission manner, such as Wi-Fi, mobile communication network (such as 3G, 4G, 5G, and so on); however, these examples are merely for exemplary illustration, and the application field of the present invention is not limited thereto. The first device transmitting module 15 of the first vehicle-mounted device 201 can transmit the first device identification information 311, the first position information 331, and the first time information of obtaining the first position information 311, to the server receiving module 21 of the server 20. The second device transmitting module 45 of the second vehicle-mounted device 40 can transmit the second device identification information 312, the second position information 332, and the second time information of obtaining the second position information 332, to the server receiving module 21 of the server 20.

The storage module 22 of the server 20 can store the first device identification information 311, the first position information 331, the first time information of obtaining the first position information 331 corresponding to each other, and store the second device identification information 312, the second position information 332, and the second time information of obtaining the second position information 332 corresponding to each other. The information stored in the storage module 22 of the server 20 can be used for sequential queries.

The impact detection module 13 of the first vehicle-mounted device 10 is mounted on periphery of the first vehicle and can detect impact forces in different directions. When the impact detection module 13 of the first vehicle-mounted device 10 detects an external impact force, the impact detection module 13 of the first vehicle-mounted device 10 can generate video collection information 34 according to an accident time and the first position information 331, and the time when the impact detection module 13 of the first vehicle-mounted device 10 detects the external impact force is defined as the accident time. In the moment when the impact detection module 13 of the first vehicle-mounted device 10 detects the external impact force, the first position information 331 of the first vehicle-mounted device 201 obtained by the first positioning module 12 of the first vehicle-mounted device 201 is the accident position information.

When the impact detection module 13 of the first vehicle-mounted device 10 detects the external impact force, the first video capturing module 15 of the first vehicle-mounted device 10 captures, according to the accident time, an accident driving video 35 within a time interval from a predetermined period before the accident time to the accident time, from the first driving record video 321. In an embodiment, for example, the predetermined period can be 30 seconds, one minute, and so on; however, these examples are merely for exemplary illustration, and the application field of the present invention is not limited thereto. The first video capturing module 15 of the first vehicle-mounted device 10 can capture the accident driving video 35 within the time interval from 30 seconds or 1 minute before the accident time to the accident time, from the first driving record video 321.

The first device transmitting module 16 of the first vehicle-mounted device 201 can transmit the video collection information 34 and the accident driving video 35 to the server 20, and the storage module 22 of the server 20 stores the accident driving video 35.

Next, the query module 23 of the server 20 can select a query range according to the first position information 331 of the video collection information 34 received by the server receiving module 21 of the server 20, and select a time interval according to the accident time contained in the video collection information 34, and then find out the second device identification information 312 when the second position information 332 is within the query range and the second time information is within the time interval. For example, the selected query range can be a geometrical pattern region centered on the accident position information, and the geometrical pattern region can be a circular region or a rectangular region, etc.; however, these examples are merely for exemplary illustration, and the application field of the present invention is not limited thereto. The selected time interval can be a period before the accident time to the accident time, and the period before the accident time can be 30 seconds, or one minute, etc.; however, these examples are merely for exemplary illustration, and the application field of the present invention is not limited thereto.

Next, the generating module 24 of the server 20 can generate video capturing information 36 according to the found second device identification information 312 and the accident time. The server transmitting module 25 of the server 20 can transmit the video capturing information 36 to the second vehicle-mounted device 40.

Next, according to the video capturing information 36, the second video capturing module 45 of the second vehicle-mounted device 40 can capture an auxiliary driving video 37 within the time interval from the predetermined period before the accident time to the accident time, from the second driving record video 322. The way of capturing the auxiliary driving video 37 can be referred to illustration of the accident driving video 35, so detailed description is omitted herein.

The second device transmitting module 46 of the second vehicle-mounted device 40 can transmit the auxiliary driving video 37 to the server 20, and the storage module 22 of the server 20 can store the auxiliary driving video 37, so that the accident driving video 35 and the auxiliary driving video 37 stored in the server 20 can be used in judging responsibility of the traffic accident.

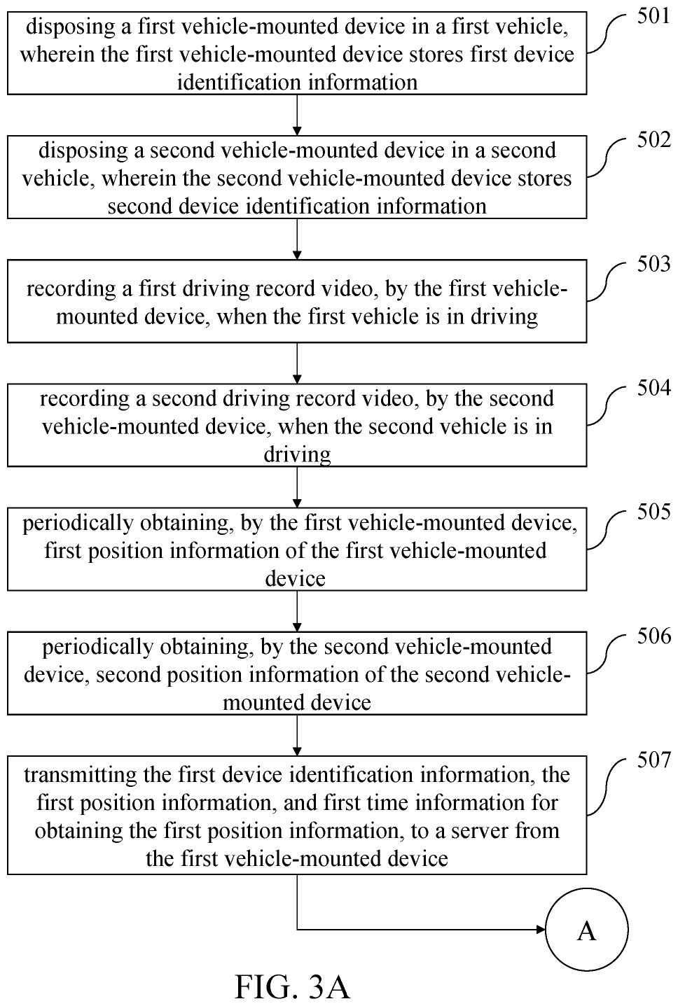

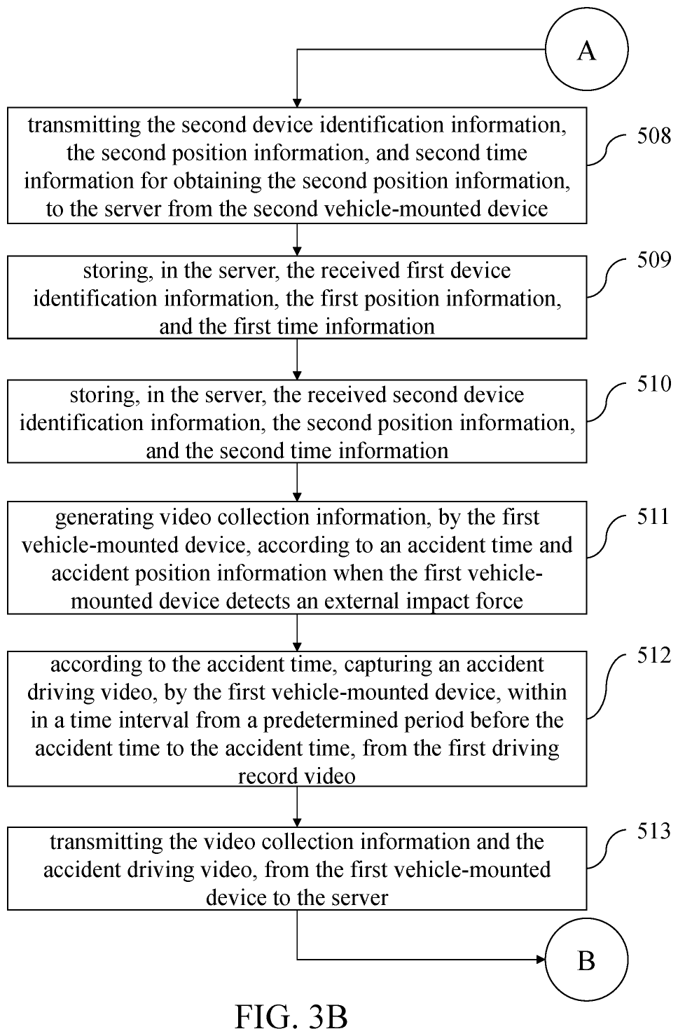

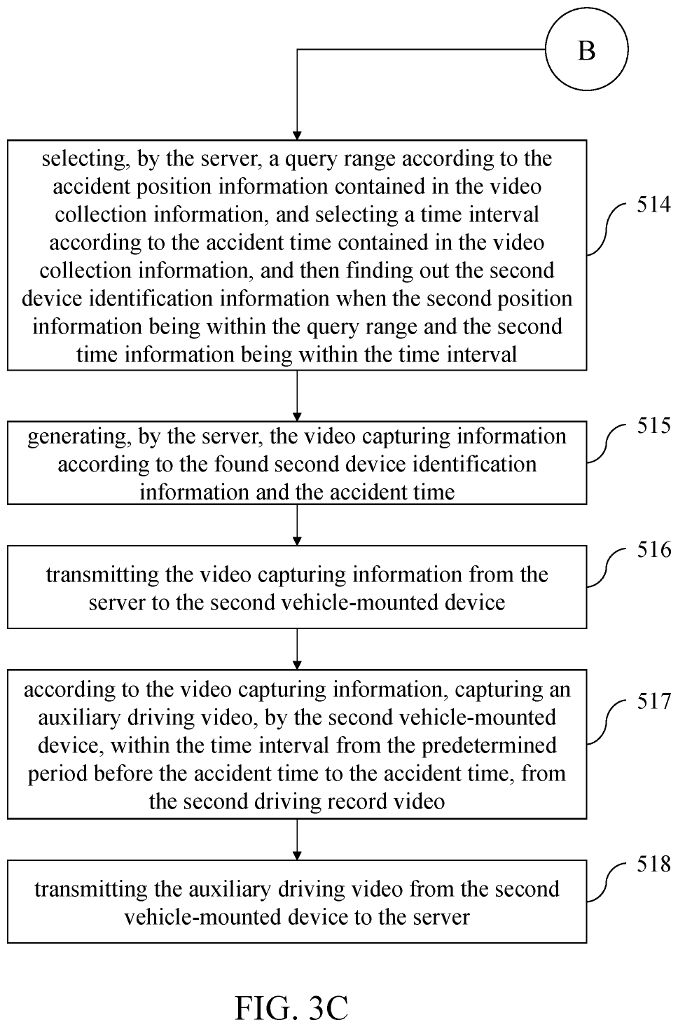

Please refer to FIGS. 3A to 3C, which are flowcharts of a driving record video collection method for a traffic accident of the present invention. The driving record video collection method for a traffic accident of the present invention includes steps 501 to 518.

First, in the step 501, a first vehicle-mounted device is disposed in a first vehicle, and the first vehicle-mounted device stores first device identification information. In the step 502, a second vehicle-mounted device is disposed in a second vehicle, and the second vehicle-mounted device stores second device identification information. Next, in the step 503, the first vehicle-mounted device records first driving record video when the first vehicle is in driving. In the step 504, the second vehicle-mounted device records second driving record video when the second vehicle is in driving. In the step 505, the first vehicle-mounted device periodically obtains first position information thereof. In the step 506, the second vehicle-mounted device periodically obtains second position information thereof. In the step 507, the first vehicle-mounted device transmits the first device identification information, the first position information, and first time information of obtaining the first position information to the server. In the step 508, the second vehicle-mounted device transmits the second device identification information, the second position information, and second time information of obtaining the second position information to the server. In the step 509, the server stores the first device identification information, the first position information, and the first time information transmitted from the first vehicle-mounted device. In the step 510, the server stores the second device identification information, the second position information, and the second time information transmitted from the second vehicle mounted device. In the step 511, when a vibration value of the first vehicle is detected to exceed a preset value, the first vehicle-mounted device generates video collection information according to an accident time and the first position information. In the step 512, according to the accident time, the first vehicle-mounted device captures an accident driving video within a time interval from a predetermined period before the accident time to the accident time, from the first driving record video. In the step 513, the first vehicle-mounted device transmits the video collection information and the accident driving video to the server. In the step 514, the server selects a query range according to accident position information contained in the video collection information, selects a time interval according to the accident time contained in the video collection information, and then finds out the second device identification information when the second position information is within the query range and the second time information is within the time interval. In the step 515, the server generates video capturing information according to the found second device identification information and the accident time. In the step 516, the server transmits the video capturing information to the second vehicle-mounted device. In the step 517, according to the video capturing information, the second vehicle-mounted device captures an auxiliary driving video within the time interval from the predetermined period before the accident time to the accident time, from the second driving record video. Eventually, in the step 518, the second vehicle-mounted device transmits the auxiliary driving video to the server.

According to above-mentioned contents, the difference between the conventional technology and the system and method the present invention is that the first vehicle-mounted device can provide the video collection information and the accident driving video to the server in the moment of a traffic accident, and the server can further select the query range according to the first position information contained in the video collection information, select the time interval according to the accident time contained in the video collection information, and then find out the second device identification information when the second position information is within the query range and the second time information is within the time interval, so as to obtain the auxiliary driving video from the second vehicle-mounted device. As a result, attributions of responsibility for the traffic accident can be judged according to the accident driving video and the auxiliary driving video.

The technical solution of the present invention can solve the conventional technical problem that it is difficult to accurately judge attributions of responsibility for a traffic accident according to words of two parties in the traffic accident and police officer's actual measurement on site, so that the technical effect of improving accuracy of judging attributions of responsibility for traffic accident according to the collected accident driving video and auxiliary driving video can be achieved.

The present invention disclosed herein has been described by means of specific embodiments. However, numerous modifications, variations and enhancements can be made thereto by those skilled in the art without departing from the spirit and scope of the disclosure set forth in the claims.

1. A driving record video collection system for a traffic accident, comprising:
a first vehicle-mounted device disposed in a first vehicle, and configured to store first device identification information, wherein the first vehicle-mounted device comprises:
a first driving recorder module configured to record a first driving record video when the first vehicle is in driving;
a first positioning module configured to periodically obtain first position information of the first vehicle-mounted device;
an impact detection module configured to detect an external impact force, and generate video collection information according to an accident time and accident position information when detecting the external impact force;
a first video capturing module configured to capture, according to the accident time, an accident driving video being from a predetermined period before the accident time to the accident time, from the first driving record video; and
a first device transmitting module configured to transmit the first device identification information, the first position information, and first time information for obtaining the first position information, and transmit the video collection information and the accident driving video;
a second vehicle-mounted device disposed in a second vehicle, and configured to store second device identification information, wherein the second vehicle-mounted device comprises:
a second driving recorder module configured to record a second driving record video when the second vehicle is in driving;
a second positioning module configured to periodically obtain second position information of the second vehicle-mounted device;
a device receiving module configured to receive video capturing information;
a second video capturing module configured to capture, according to the video capturing information, an auxiliary driving video being from the predetermined period before the accident time to the accident time, from the second driving record video; and
a second device transmitting module configured to transmit the second device identification information, the second position information, and second time information for obtaining the second position information, and transmit the auxiliary driving video; and
a server comprising:
a server receiving module configured to receive the first device identification information, the first position information and the first time information from the first device transmitting module, and receive the video collection information and the accident driving video from the first device transmitting module, and receive the second device identification information, the second position information and the second time information from the second device transmitting module independent of the accident, and receive the auxiliary driving video from the second device transmitting module;
a storage module configured to store the first device identification information, the first position information, and the first time information, and store the second device identification information, the second position information and the second time information;
a query module configured to select a query range according to the accident position information contained in the video collection information, and select a time interval according to the accident time contained in the video collection information, and then find out the second device identification information when the second position information is within the query range and the second time information is within the time interval;
a generating module configured to generate the video capturing information according to the found second device identification information and the accident time; and
a server transmitting module configured to transmit the video capturing information to the second device receiving module.

2. The driving record video collection system according to claim 1, wherein each of the first device identification information and the second device identification information is a media access control (MAC) address.

3. The driving record video collection system according to claim 1, wherein each of the first position information and the second position information is global positioning coordinate information.

4. The driving record video collection system according to claim 1, wherein the query range is a geometrical pattern region centered on the accident position information.

5. A driving record video collection method for a traffic accident, comprising:
disposing a first vehicle-mounted device in a first vehicle, wherein the first vehicle-mounted device stores first device identification information;
disposing a second vehicle-mounted device in a second vehicle, wherein the second vehicle-mounted device stores second device identification information;
recording a first driving record video, by the first vehicle-mounted device, when the first vehicle is in driving;
recording a second driving record video, by the second vehicle-mounted device, when the second vehicle is in driving;
periodically obtaining, by the first vehicle-mounted device, first position information of the first vehicle-mounted device;
periodically obtaining, by the second vehicle-mounted device, second position information of the second vehicle-mounted device;
transmitting the first device identification information, the first position information, and first time information for obtaining the first position information, to a server from the first vehicle-mounted device;
transmitting the second device identification information, the second position information, and second time information for obtaining the second position information, independent of the accident, to the server from the second vehicle-mounted device;
storing, in the server, the received first device identification information, the first position information, and the first time information;
storing, in the server, the received second device identification information, the second position information, and the second time information;
generating video collection information, by the first vehicle-mounted device, according to an accident time and accident position information when the first vehicle-mounted device detects an external impact force;
according to the accident time, capturing an accident driving video, by the first vehicle-mounted device, within in a time interval from a predetermined period before the accident time to the accident time, from the first driving record video;
transmitting the video collection information and the accident driving video, from the first vehicle-mounted device to the server;
selecting, by the server, a query range according to the accident position information contained in the video collection information, and selecting a time interval according to the accident time contained in the video collection information, and then finding out the second device identification information when the second position information being within the query range and the second time information being within the time interval;
generating, by the server, the video capturing information according to the found second device identification information and the accident time;
transmitting the video capturing information from the server to the second vehicle-mounted device;
according to the video capturing information, capturing an auxiliary driving video, by the second vehicle-mounted device, within the time interval from the predetermined period before the accident time to the accident time, from the second driving record video; and
transmitting the auxiliary driving video from the second vehicle-mounted device to the server.

6. The driving record video collection method according to claim 5, wherein each of the first device identification information and the second device identification information is a media access control address.

7. The driving record video collection method according to claim 5, wherein each of the first position information and the second position information is global positioning coordinate information.

8. The driving record video collection method according to claim 5, wherein the query range is a geometrical pattern region centered on the accident position information.
